(19) United States
(12) Patent Application Publication
(10) Pub. No.: US 2008/0275854 A1
(43) Pub. Date: Nov. 6, 2008

(54) PERIPHERAL OBJECT COMMUNICATION METHOD, APPARATUS, AND SYSTEM

(76) Inventors: Yusuke Doi, Yokohama-shi (JP); Shirou Wakayama, Kawasaki-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/136,278

(22) Filed: Jun. 10, 2008

(30) Foreign Application Priority Data
Dec. 9, 2003 (JP) 2003-410071

(51) Int. Cl. G06F 7/06; G06F 17/30

(52) U.S. Cl. 707/3; 707/E17.014; 707/E17.009

(57) ABSTRACT

In accordance with respective embodiments of the present invention, flexibility can be improved due to an arbitrary communication system being made available, and convenience can be improved due to visible identification information being made unnecessary. Concretely, an ID-metadata database server is prepared in which metadata in which displaying information and a communication system are described for each peripheral object are stored, and when a display apparatus detects a peripheral object in accordance with receiving a radio signal, the display apparatus acquires metadata of the detected peripheral object from the ID-metadata database server, and executes communication with a peripheral object representative server on the basis of a communication system described in the metadata.

### CROSS-REFERENCE TO RELATED APPLICATIONS

This application is a division of and claims the benefit of priority under 35 U.S.C. §120 from U.S. application Ser. No. 11/006,724, filed Dec. 8, 2004, and claims the benefit of priority under 35 U.S.C. §119 from Japanese patent Application No. 2003-410071, filed Dec. 9, 2003. The entire contents of which are incorporated herein by reference.

### BACKGROUND OF THE INVENTION

1. Field of the Invention

The present invention relates to a peripheral object communication method and apparatus which are for displaying other apparatuses or material bodies existing in the circumference (hereinafter, called peripheral objects as well), and for communicating with those, and in particular, to a peripheral object communication method, apparatus, and system which can improve flexibility and convenience.

2. Description of the Related Art

Conventionally, as an azimuth-measuring technique used for a communication method with peripheral objects, for example, there has been SmartBat (SmartBat; manufactured by Olivetti Research Laboratory) which uses ultrasonic waves. SmartBat has the advantage that peripheral objects can be highly accurately (in units of one cubic inch) azimuth-measured. However, it is necessary to embed ultrasonic sensors in the entire azimuth-measuring region.

In contrast thereto, for example, Jpn. Pat. Appln. KOKAI Publication No. 2003-152615 and Jpn. Pat. Appln. KOKAI Publication No. 2001-142825 disclose arts for which ultrasonic sensors are not required.

In Jpn. Pat. Appln. KOKAI Publication No. 2003-152615, with a technique of communicating among a plurality of PDAs (portable information terminals) through Bluetooth as a model example, a technique of communicating by an arbitrary data communication apparatus and communication system is disclosed (refer to the paragraphs [0129] and [0130]). In Jpn. Pat. Appln. KOKAI Publication No. 2001-142825, there is disclosed a technique of identifying a target due to visible identification information being imaged (refer to claim 1 or the like).

However, usually, although there is no problem in a peripheral object communication method as described above, in accordance with study by the present inventor, there will still be room for improvement in the techniques respectively.

For example, in the case of the technique disclosed in Jpn. Pat. Appln. KOKAI Publication No. 2003-152615, although various communication systems can be applied (refer to the paragraph [0129]), because the communication means is changed to an applied communication system (refer to the paragraph [0130]), an arbitrary communication system different from the applied communication system cannot be used, and there is room for improvement in the flexibility.

On the other hand, in the case of the technique disclosed in Jpn. Pat. Appln. KOKAI Publication No. 2001-142825, because it is necessary to image visible identification information (refer to claim 1), there is the problem that no more than one target can be selected. In addition thereto, because a problem that the image pickup apparatus must be lifted up where required is brought about, there is room for improvement in the convenience.

### BRIEF SUMMARY OF THE INVENTION

An object of the present invention is to provide peripheral object communication method, apparatus, and system which can improve flexibility due to an arbitrary communication system being made to be available, and which can improve convenience due to visible identification information becoming disused.

According to a first aspect of the present invention, there is provided a peripheral object communication method comprising receiving a radio signal output from a peripheral object, and identifying the peripheral object on the basis of the obtained received signal, detecting an azimuth of the peripheral object on the basis of the received signal, acquiring metadata corresponding to the identified peripheral object from a storage apparatus storing metadata in which displaying information and a communication system are described for each peripheral object, displaying an icon corresponding to the peripheral object at a position corresponding to the azimuth on a screen on the basis of displaying information in the metadata, and executing communication corresponding to the peripheral object on the basis of a communication system described in the metadata corresponding to the icon when the icon is selected.

According to a second aspect of the present invention, there is provided A peripheral object communication apparatus comprising a metadata storage device configured to store metadata in which displaying information and a communication system are described for each peripheral object which outputs a radio signal to circumference, a radio signal receiving device configured to receive a radio signal output from the peripheral object, and to transmit the obtained received signal, an object identifying device configured to identify the peripheral object on the basis of the received signal, an azimuth detecting device configured to detect an azimuth of the peripheral object on the basis of the received signal, a metadata acquiring device configured to acquire metadata of the identified peripheral object from the storage apparatus, an icon displaying device configured to display an icon corresponding to the peripheral object at a position corresponding to the azimuth on a screen on the basis of displaying information in the metadata, and a communication device configured to execute communication corresponding to the peripheral object on the basis of a communication system described in the metadata corresponding to the icon when the icon is selected.

Accordingly, in the first and second aspects of the present invention, when the peripheral objects are identified by receiving the radio signals, the metadata of the identified peripheral objects are acquired from the storage device storing the metadata in which displaying information and a communication system are described for each peripheral object, and communication is executed on the basis of the communication systems described in the metadata. In accordance therewith, the flexibility can be improved due to an arbitrary communication system being made to be available, and the convenience can be improved due to visible identification information becoming disused.

### BRIEF DESCRIPTION OF THE SEVERAL VIEWS OF THE DRAWING

FIG. 1 is a typical diagram showing a configuration of a network communication system relating to a first embodiment of the present invention.

FIG. 2 is a typical diagram showing one example of metadata in the embodiment.

FIG. 3 is a typical diagram showing a configuration of a display apparatus in the embodiment.

FIG. 4 is a typical diagram showing a display example of a screen display unit in the embodiment.

FIG. 5 is a typical diagram showing a configuration of an information processing device in the embodiment.

FIG. 6 is a typical diagram for explanation of a function of a peripheral object azimuth estimating unit in the embodiment.

FIG. 7 is a typical diagram showing a configuration of an icon list in the embodiment.

FIGS. 8 and 9 are flowcharts for explanation of operations in the embodiment.

FIG. 10 is a typical diagram showing an appearance of a screen display unit of a display apparatus according to a second embodiment of the present invention.

FIG. 11 is a typical diagram showing an appearance of a screen display unit of a display apparatus according to a third embodiment of the present invention.

FIG. 12A is a plan view and a side view of a display apparatus according to a fourth embodiment of the present invention.

FIG. 12B is an outside drawing of the display apparatus.

FIG. 13 is a typical diagram showing a configuration of a network communication system in the embodiment.

FIGS. 14 to 20 are typical diagrams showing configurations of network communication systems in fifth thorough eleventh embodiments of the present invention.

### DETAILED DESCRIPTION OF THE INVENTION

Hereinafter, respective embodiments of the present invention will be described with reference to the drawings.

### First Embodiment

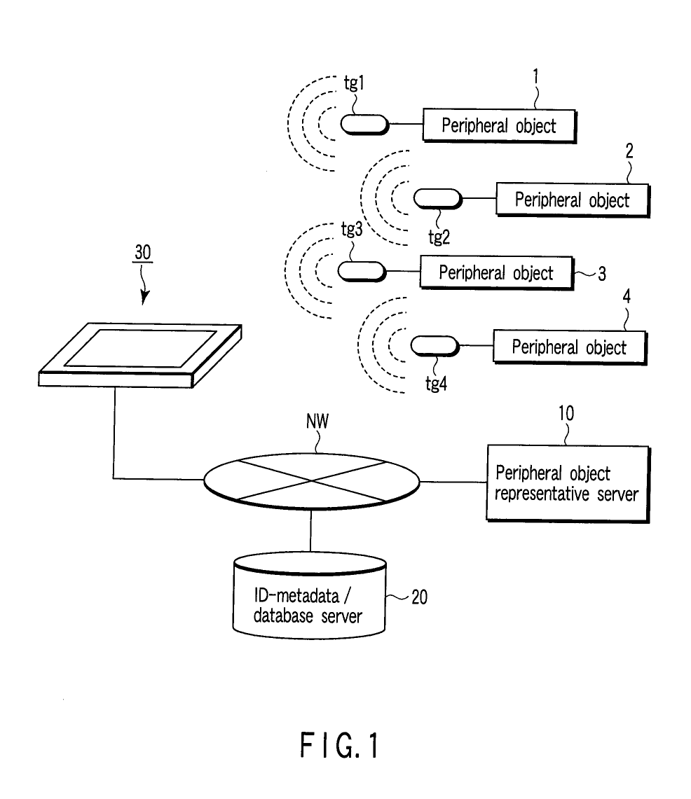

FIG. 1 is a typical diagram showing a configuration of a network communication system according to a first embodiment of the present invention. In this system, a peripheral object representative server 10, an ID-metadata/database server 20, and a display apparatus 30 are connected to one another via a network NW. Peripheral objects 1 to 4 separately having radio tags (RF-ID) tg1 to tg4 which output radio signals are disposed in the circumference of the display apparatus 30. Peripheral objects are other apparatuses or material bodies existing in the circumference.

Here, the radio tags tg1 to tg4 respectively have a function of outputting a radio signal denoting a peripheral object ID for identifying the corresponding peripheral objects 1 to 4 (peripheral object ID), to the circumference. As the radio signal, here, an electromagnetic wave signal in accordance with a radio tag (RF-ID) is used. However, it is not limited thereto, an electromagnetic wave signal or an infrared signal through Bluetooth or a wireless LAN may be used.

The peripheral objects 1 to 4 are arbitrary apparatuses or material bodies which are identified in accordance with peripheral object IDs, and respectively have the radio tags tg1 to tg4.

The peripheral object representative server (first server apparatus) 10 has a memory (not illustrated) in which related information is stored in advance for each of the peripheral objects 1 to 4, and has a function in which, when a request for providing information on one of the peripheral objects 1 to 4 is received via the network NW from the display apparatus 30, the related information on the corresponding peripheral object in the memory is returned to the display apparatus 30 in accordance with the request for providing information. Further, the peripheral object representative server 10 has a function in which, when a control instruction for one of the peripheral objects 1 to 4 is received via the network NW from the display apparatus 30, the peripheral object is controlled in accordance with the control instruction.

Note that there is no need for the peripheral object representative server 10 to have both of the function of answering related information and the function of controlling a peripheral object, and the function of answering or the function of controlling may be omitted in accordance with a characteristic of a peripheral object. Further, it is not limited to a form in which the plurality of peripheral objects 1 to 4 are made to correspond to the one peripheral object representative server 10, and it may be a form in which a plurality of peripheral object representative servers may be made to correspond to one peripheral object.

The peripheral object representative server 10 provides the calculating ability and the communicating ability for operations and acquiring information, for example, to the peripheral object 4 formed from a material body without sufficient calculating ability and communicating ability, and in particular, has a function of deputizing a function of providing information on and operations for a single or a plurality of peripheral objects 4, . . . including the peripheral objects 4.

The ID-metadata/database server (second server apparatus) 20 has a function in which, when a request for acquiring metadata relating to one of the peripheral objects 1 to 4 is received, metadata including a destination address on the network NW or an identifier of a webpage which denotes the peripheral object representative server 10 is returned to a requester. Here, the destination address is, for example, an IP address. However, it is not limited thereto, and a domain name may be used as the destination address. The identifier of the webpage is a URL (Uniform Resource Locator). However, it is not limited thereto, and a URN (Uniform Resource Name) or a URI (Uniform Resource Identifier) may be used as the identifier of the webpage.

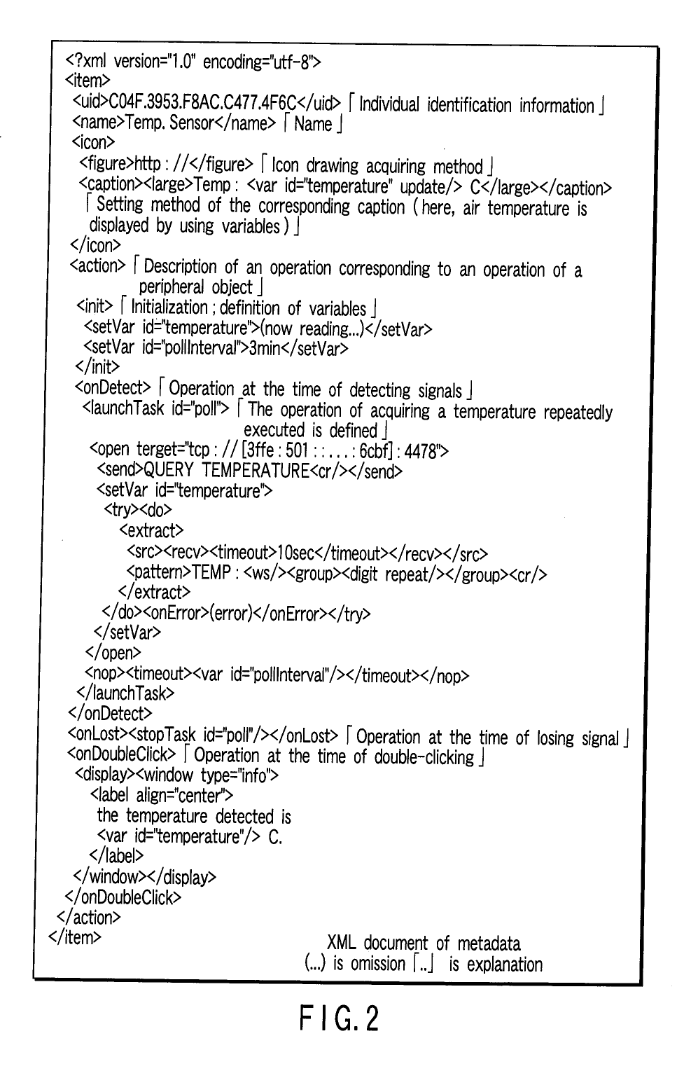

Metadata is a structured document written in a general purpose description language such as XML, and it is not limited to XML. Any general purpose description language used on the World Wide Web can be suitably used. Metadata is, as one example is shown in FIG. 2, composed of factors needed for describing the functions of the peripheral objects 1 to 4 among factors (E1) to (E5) as shown hereinafter.

(E1) a peripheral object name, (E2) a peripheral object ID (individual identification information), (E3) a peripheral object icon drawing acquiring method (a communication system such as a communication procedure or the like, a URL, or the like), (E4) a peripheral object manufacturer, and (E5) a peripheral object operation.

Note that FIG. 2 shows an example in which the metadata is formed from the factors (E1) to (E3), and (E5).

In particular, operations corresponding to the operations for the peripheral objects among factors (E51) to (E55) as follows are included the peripheral object operation of the factor (E5).

(E51) Initializing operation: an operation to be executed in advance of the other operations.

(E52) Detailed information acquiring operation: an operation for acquiring detailed information relating to the peripheral objects 1 to 4 (e.g.: real-time data or the like).

(E53) Operation at the time of detecting signals: an operation which is carried out when the display apparatus 30 detects radio signals of the radio tags tg1 to tg4 of the peripheral objects 1 to 4. The operation is used in a case in which a method for communication with the display apparatus 30 is requested to be registered with the peripheral object representative server 10 in order for the peripheral objects 1 to 4 to transmit a change of the state to other peripheral objects.

(E54) Operation at the time of losing signals: an operation which is carried out when the display apparatus 30 loses radio signals of the radio tags tg1 to tg4.

(E55) Action corresponding operation: an operation corresponding to an input by a user.

Note that, the action corresponding operation (E55) is classified into operations (E55-1) to (E55-6) as follows.

(E55-1) Opening/editing operation: an operation which is carried out when opening/editing is selected from some menu.

(E55-2) Operation at the time of clicking: an operation which is carried out at the time of clicking one of icons ic1 to ic4. Click means a pointer button push down→a pointer button push down release within a given time determined in advance when there is a pointer within a range of displaying the icons ic of the peripheral objects.

(E55-3) Operation at the time of double-clicking: an operation which is carried out at the time of double-clicking an icon. An operation which is most frequently used (an access to a user interface for operating or the like) is allocated to this operation. Double-clicking means operations of clicking twice within a given time determined in advance.

(E55-4) Operation at the time of metaclicking: an operation which is carried out at the time of metaclicking an icon. Metaclick means (i) a click operation by a secondary button of a mouse (generally, the rightmost button), (ii) a click operation in a state of pushing down a special key, (iii) an operation of maintaining a state of pushing down a button of a mouse or the like for a given period. It is determined by a peripheral object icon control unit 42 of the display apparatus 30 that which operation is actually allocated to the metaclick. Generally, the operation at the time of metaclicking has the effect of list-displaying operations which are available to the peripheral objects 1 to 4.

(E55-5) Operation at the time of dropping: when the icons ic1 to ic4 are placed on other factors (factors to be dropped), it is described that what communication output is carried out with respect to the factors to be dropped. Dropping means that a pointer button push down within a range of displaying the icons ic of the peripheral objects→moving the pointer as is in the state of the pointer button push down→the pointer button push down release in a state in which this peripheral object icon is superimposed on an icon to be a target.

(E55-6) Operation at the time of being dropped: when the other factors are placed on the icons ic1 to ic4, it is described that how the outputs by the other factors are transmitted to the peripheral objects 1 to 4. Being-dropped means the effect that another icon is dropped on a peripheral object icon.

Metadata was as described above. Next, description of the ID-metadata/database server 20 will be started again. The ID-metadata/database server 20 may exist so as to be distributed by using a technique such as a distributed hash table, DNS, or the like. Further, an individual or an arbitrary group may prepare his/her or their own ID-metadata/database server. In this case, the individual or the arbitrary group may modify metadata to be acquired in accordance with the purpose.

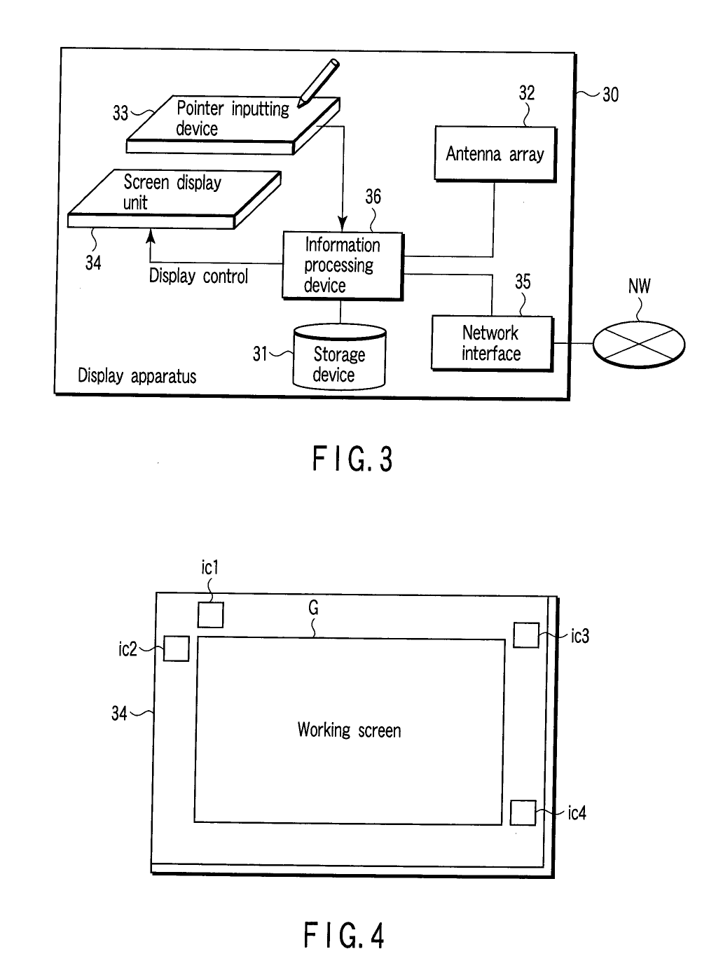

As shown in FIG. 3, the display apparatus (peripheral object communication apparatus) 30 has a storage device 31, an antenna array 32, a pointer inputting device 33, a screen display unit 34, a network interface 35, and an information processing device 36.

The storage device 31 is a memory which can read from/write into the information processing device 36, and peripheral object IDs and metadata are stored so as to be associated with one another.

The antenna array 32 has a function of receiving radio signals output from the peripheral objects 1 to 4, and of inputting the obtained received signals to the information processing device 36 via a serial circuit or the like. To describe in detail, the antenna array 32 may use any of a method (A) or a method (B).

In the method (A), the antenna array 32 is controlled by the information processing device 36.

In the method (B), the antenna array 32 actively controls the phases (emission azimuths) of emission signals from the respective antennas, and emits emission signals having a directional wave whose width is made to be narrow. When a radio signal is received from, for example, the peripheral object 1 in accordance with an emission, the antenna array 32 returns the radio signal to the information processing device 36 such that the emission azimuth at a point in time of receiving is estimated as an azimuth at which the peripheral object 1 exists.

In the case of method (B), the antenna array 32 emits a radio wave, for example, with respect to a surface parallel to the display surface of the screen display unit 34, and may detect azimuths of the peripheral objects existing in the circumference of the display apparatus 30.

In both of the methods (A) and (B), azimuth setting by an operation by a user at the time of turning the power source on, and error correction by an operation by a user at the time of operating may be executed. Concretely, learning (azimuth setting and error learning) for estimating an azimuth of a source of emitting radio waves on the basis of a value of field intensity of each antenna may be carried out.

The antenna array 32 as described above is enabled to use, for example, an adaptive array from the standpoint of the fact that the directivity can be adjusted. The adaptive array is a system in which directivity is optimized in accordance with a radio wave environment, and a disturbing wave is suppressed. When the received signals of the respective antenna elements are multiplied by complex weights, and synthesized and output, the weight directivity is adjusted. Here, when a weight is determined, it is recommended that azimuth setting or error learning be carried out by an operation by a user.

At least information of a combination of (a radio tag identifier, an azimuth) is carried over the information processing device for each detected radio tag from the antenna array 32. Note that, in order to estimate a distance, it is preferable that, in addition to the information of this combination, a field intensity or information proportional to the field intensity is carried over.

The pointer inputting device 33 is to input an operating input signal to the information processing device 36 by an operation by a user, and a mouse, a pen tablet, or the like can be used. The operating input signal includes at least a position of a pointer (x; y) and a format of operating input (event type). As the formats of operating input, there are at least three types of a pointer button push down, a pointer button push down release, a pointer button movement.

The screen display unit 34 is a display device such as a liquid crystal display or the like, which is controlled by the information processing device 36, and for example, as shown in FIG. 4, has a function of displaying the icons ic1 to ic4 corresponding to the peripheral objects 1 to 4 in the circumference of a general working screen (desktop) G. The screen display unit 34 and the pointer inputting device 33 are combined with one another. For example, the pointer inputting device 33 inputs an operating input signal to the information processing device 36 in accordance with an operation of clicking each of the respective icons ic1 to ic4 displayed by the screen display unit 34.

The network interface 35 has an interface function between the network NW and the information processing device 36, and in the present embodiment, a wire communication function with respect to a network such as Ethernet (registered trademark) or the like is used. However, it is not limited thereto, a wireless communication function with respect to a network such as a wireless LAN or Bluetooth or the like may be used.

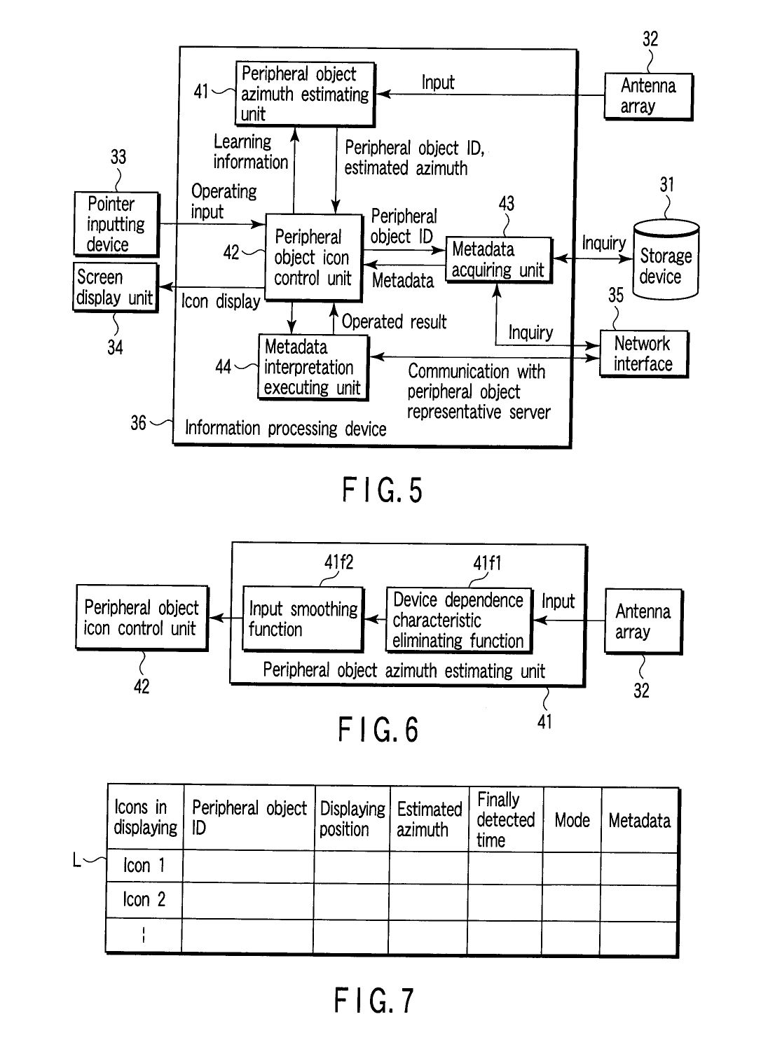

As shown in FIG. 5, the information processing device 36 has a peripheral object azimuth estimating unit 41, a peripheral object icon control unit 42, a metadata acquiring unit 43, and a metadata interpretation executing unit 44.

The peripheral object azimuth estimating unit 41 has the following functions (41i) and (41ii).

(41i) A function of processing angle information in the received signal on the basis of an received signal input from the antenna array 32, and of estimating an azimuth or a position at which there is a strong probability that a peripheral object ic exists.

(41ii) A function of transmitting the estimated result and a peripheral object ID to the peripheral object icon control unit 42. The processing onto angle information includes a function 41f1 of eliminating the device dependence characteristic, and a function 41f2 of smoothing the angle information thereafter as shown in FIG. 6.

The device dependence characteristic eliminating function 41f1 is a function of correcting the device dependent input signal characteristic which is peculiar to the antenna array 32 and a wireless communication device which can estimate the azimuths of similar radio tags tg. As the correction, there is a method in which an azimuth input from the antenna array 32 is corrected with reference to a conversion table storing learned results by using learning about which the user is concerned, or the like.

The input smoothing function 41f2 has a function of smoothing an angle denoted by angle information as shown in the following equation.

dₒᵤₜ=dᵢₙ+α×|dₚᵣₑᵥ−dᵢₙ|

Here, dᵢₙ is an output of the device dependence characteristic eliminating function 41f1, and dₚᵣₑᵥ is a value of dₒᵤₜ at the time of the previous detecting of the same radio tag tg. α is a smoothing coefficient, and is determined by utilizing a time tₚᵣₑᵥ into which dₚᵣₑᵥ is computed, a current time t_{now}, and a constant M. The characteristic of the smoothing coefficient α fluctuates from 0 up to 1 in accordance with a value of tₚᵣₑᵥ−t_{now}. Further, the characteristic of the smoothing coefficient α is made to be zero when tₚᵣₑᵥ−t_{now} is over the constant M, and approximates to 1 as tₚᵣₑᵥ−t_{now} approximates to 0. An example of equations for calculating the smoothing coefficient α is shown as follows.

α=1−(t_{now}−tₚᵣₑᵥ)/M (1)

α=0 (2)

Equation (1) is in the case of t_{now}−tₚᵣₑᵥ≦M. Equation (2) is in the case of t_{now}−tₚᵣₑᵥ≧M.

The above-described function (41i) enables that, for example, when the respective antennas of the antenna array 32 have angles different from each other, the field intensities of the respective radio signals denoted by the outputs of the smoothing function 41f2 are synthesized, and on the basis of the synthesized result, the azimuths or the positions of the peripheral objects are estimated. Or, the azimuths may be detected by the radio signals, and the distances may be estimated on the basis of the field intensities of the radio signals, and the positions may be detected on the basis of the azimuths and the distances.

The peripheral object icon control unit 42 has the following respective functions (42f1) to (42f4).

(42f1) A function in which the icons ic1 to ic3 which are being currently displayed are managed with an icon list L as shown in FIG. 7.

(42f2) A function in which, when a peripheral object ID which does not exist in the icon list L is detected by the peripheral object azimuth estimating unit 41, an icon ic4′ denoting an unknown peripheral object ic4 is displayed at a position corresponding to the detected azimuth on the screen display unit 34.

(42f3) A function in which information for displaying the icon ic4 (e.g.: an icon drawing acquiring method) corresponding to the unknown peripheral object ic4 is acquired from metadata, and the icon ic4 is displayed in place of the unknown icon ic4′ on the screen display unit 34.

(42f4) A function in which, when an operating input with respect to the icons ic1 to ic4 is received from the pointer inputting device 33, an operational identifier for identifying the operating input and the metadata are transmitted to the metadata interpretation executing unit 44.

Note that the icon list L is composed of a table including peripheral object IDs, currently displaying positions, currently detected azimuths, finally detected times, states of inputting from a user (modes), metadata corresponding to the peripheral objects 1 to 4, or the like.

The metadata acquiring unit 43 acquires metadata from the ID-metadata/database server 20 in accordance with a series of predetermined communication procedure, and transmits the metadata to the peripheral object icon control unit 42. Note that the metadata acquiring unit 43 has a function in which the metadata acquired previously are recorded in the storage device 31 within a range of a given capacity from the standpoint of guaranteeing a prompt response, and the storage device 31 is retrieved before inquiring the ID-metadata/database server 20 of the metadata.

The metadata interpretation executing unit 44 has the following functions (44f1) and (44f2).

(44f1) A function of interpreting and executing an initializing operation and an operation at the time of detecting signals which have been described in the metadata received from the peripheral object icon control unit 42.

(44f2) A function of interpreting some of the metadata corresponding to the operational identifier (argument) received from the peripheral object icon control unit 42, and executing a corresponding task. As the task, for example, there are communication, a judgment, a screen display, or the like for satisfying a request from a user.

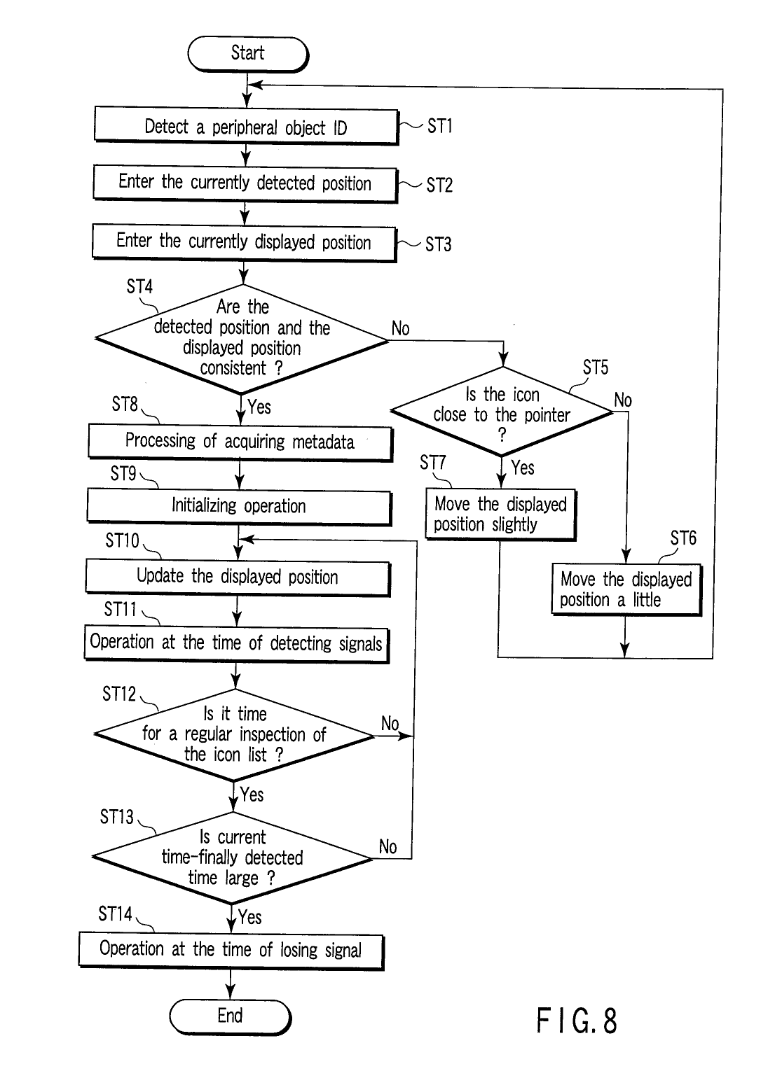

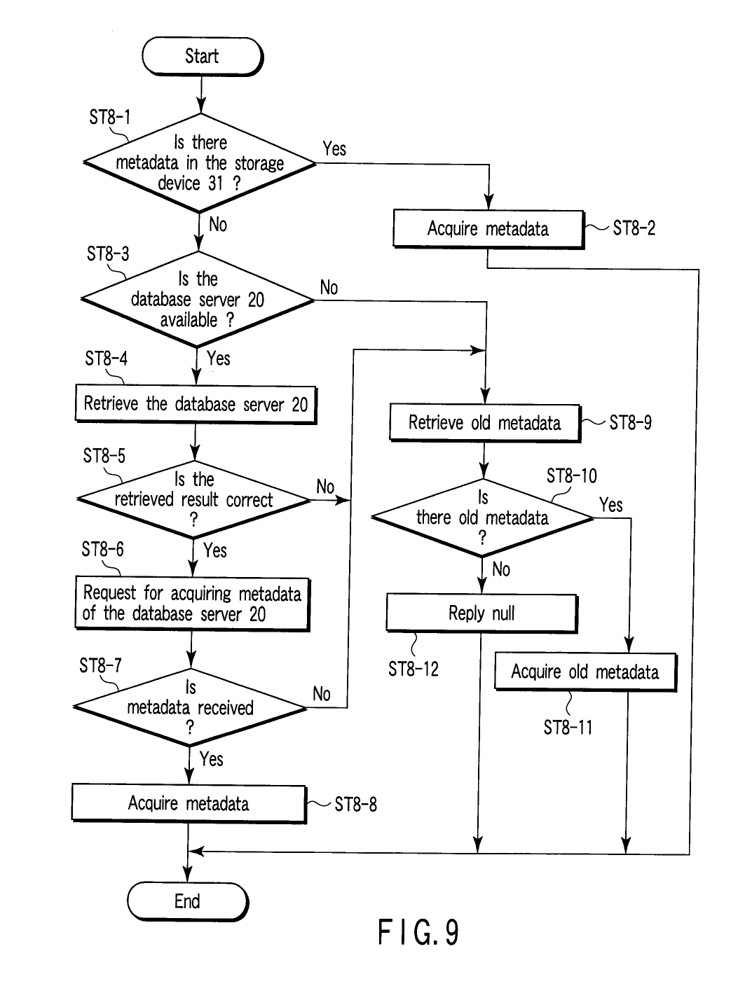

Next, operations of the network communication system configured as described above will be described by using the flowcharts of FIG. 8 and FIG. 9.

Now, the display apparatus 30 retrieves the radio tags tg1 to tg4 existing in the circumference by utilizing the antenna array 32.

The antenna array 32 receives radio signals output from the peripheral objects 1 to 4, and inputs the obtained received signal to the information processing device 36 via the serial circuit or the like.

In the information processing device 36, the peripheral object azimuth estimating unit 41 processes angle information in the received signal on the basis of an received signal input from the antenna array 32, and estimates an azimuth or a position at which there is a strong probability that a peripheral object ic exists. The peripheral object azimuth estimating unit 41 transmits the estimated result and the peripheral object ID in the received signal to the peripheral object icon control unit 42.

The peripheral object icon control unit 42 operates so as to provide an interface which is easy to operate for a user. Concretely, as shown in FIG. 8, the peripheral object icon control unit 42 detects the peripheral object ID and the position input from the peripheral object azimuth estimating unit 41 (ST1). The peripheral object icon control unit 42 enters the peripheral object ID and the position in the “currently detected positions” of the icon list L (ST2), and the “currently displaying positions” of the actual peripheral object icon ic is gradually made to be close to the “currently detected positions” (ST3 to ST7).

To describe in detail, it is judged whether or not the detected position and the displaying position are consistent with one another (ST4), and when the icon is a long way from the pointer, the displaying position is slightly moved (ST5, ST6). When the icon is close to the pointer, the displaying position is further slightly moved (ST5, ST7). In accordance therewith, a situation is avoided in which, when the user makes the pointer approach to the icons ic1 to ic4 with the intention of operating, it is difficult for the user to operate due to the icons ic1 to ic4 being moved.

Further, when the pointer is positioned in the region of the icon ic1, in the case of detecting a pointer button push down, the icon ic1 is made to be in an “input standby mode”. In the input standby mode, the “currently displaying positions” of the icon ic1 is not made to be the “currently detected positions”, and is made to follow (drag) the movement of the pointer, or a pointer button push down release is detected.

The peripheral object icon control unit 42 requests the metadata acquiring unit 43 of an acquisition of metadata corresponding to the unknown peripheral object ic4. In accordance therewith, processings of acquiring metadata (ST8; ST8-1 to ST8-11) are executed. As shown in FIG. 9, the metadata acquiring unit 43 acquires metadata from the storage device 31 or the ID-metadata/database server 20.

To describe in detail, first, the metadata acquiring unit 43 acquires metadata from the storage device 31 (ST8-1 to ST8-2), and when there is no metadata in the storage device 31, the metadata acquiring unit 43 acquires metadata from the ID-metadata/database server 20 (ST8-3 to ST8-8). When there is no metadata in the ID-metadata/database server 20 as well, the metadata acquiring unit 43 acquires old metadata from the storage device 31 (ST8-9 to ST8-11). When there is no old metadata as well, the metadata acquiring unit 43 replies that there is no metadata (null) to the peripheral object icon control unit 42 (ST8-12).

However, here, a case is described in which the metadata acquiring unit 43 could acquire metadata at one of steps ST8-1 to ST8-11. The metadata acquiring unit 43 transmits the metadata to the peripheral object icon control unit 42.

When the peripheral object icon control unit 42 acquires metadata (ST8), the peripheral object icon control unit 42 acquires information for displaying the icon ic4 from the metadata, and displays the icon ic4 in place of the unknown icon ic4′ on the screen display unit 34.

Next, the peripheral object icon control unit 42 carries out an initializing operation (ST9), and thereafter, the peripheral object icon control unit 42 updates the displaying positions of the icons ic1 to ic4 in the same way as those at steps ST1 to ST7 described above (ST10).

Further, when the peripheral object icon control unit 42 receives operating inputs with respect to the icons ic1 to ic4 from the pointer inputting device 33, the peripheral object icon control unit 42 transmits an operational identifier for identifying the operating inputs and the metadata to the metadata interpretation executing unit 44.

The metadata interpretation executing unit 44 executes an operation at the time of detecting signals on the basis of the operational identifier and the metadata (ST11). For example, the metadata interpretation executing unit 44 transmits a request for providing information on or a control instruction for the peripheral object 1 as the operation at the time of detecting signals to the peripheral object representative server 10 via the network NW.

In accordance therewith, when the peripheral object representative server 10 receives the request for providing information, the peripheral object representative server 10 replies the related information on the peripheral object to the display apparatus 30 in accordance with the request for providing information. Further, when the peripheral object representative server 10 receives the control instruction, the peripheral object representative server 10 controls the peripheral object in accordance with the control instruction. In this way, an operation at the time of detecting signals is executed.

Hereinafter, the peripheral object icon control unit 42 periodically inspects the icon list L (ST12), and compares a finally detected time and a current time (ST13). As a result of the comparison, the peripheral object icon control unit 42 judges that it is a signal loss with respect to a peripheral object which is not detected for a given time determined in advance, and makes the metadata interpretation executing unit 44 execute an operation at the time of losing signal (ST14).

The metadata interpretation executing unit 44 executes an operation at the time of losing signal, and erases the icons ic from the screen display unit 34, and writes metadata into the storage device 31.

As described above, in accordance with the present embodiment, when metadata in which information for displaying and a communication system are described is prepared for each of the peripheral objects 1 to 4, and the peripheral objects 1 to 4 are detected by receiving radio signals, the metadata of the detected peripheral objects 1 to 4 are acquired, and because communication is executed on the basis of a communication system described in the metadata, the flexibility can be improved due to an arbitrary communication system being made to be available, and the convenience can be improved due to visible identification information being made to be unnecessary.

To describe in detail, in the present embodiment, it can be realized that the peripheral objects 1 to 4 such as equipment using various communication means and communication procedures, material bodies without calculating abilities, or the like are controlled in the same method as seen from a user via the icons ic1 to ic4 on the display apparatus 30, or the related information are acquired.

Further, in particular, in the case in which a communication destination address or a communication procedure corresponding to an apparatus or a material body is not obvious, the problem that communication for satisfying a request cannot be carried out is solved. Due to a communication destination address and the communication procedure being acquired in a state of being transparent for the user, and being executed in accordance with a request from the user, various material bodies can be operated and viewed in a system which is in the same way as seen from the user. Further, when an acquisition of information, an operation of information, or the like is carried out with respect to a material body without the calculating ability, an interface which has the consistency with the above-described system, and which is intuitively understandable from the standpoint of the user is provided.

### Second Embodiment

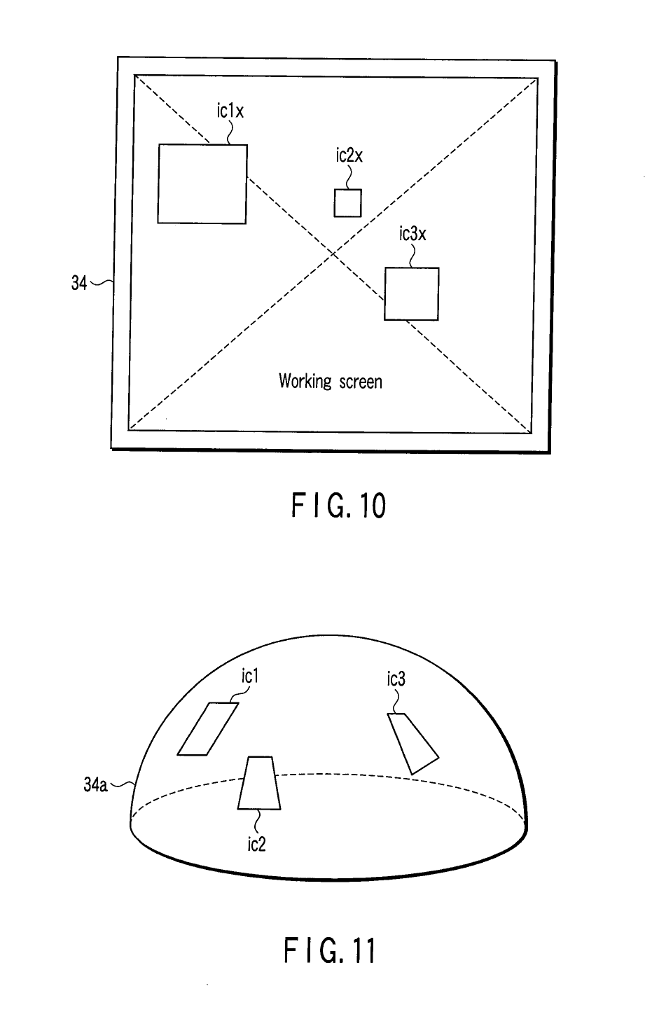

FIG. 10 is a typical diagram showing an appearance of a screen display unit of a display apparatus according to a second embodiment of the present invention, and portions which are the same as those in the above-described drawing are denoted with the same reference numerals, and detailed descriptions thereof will be omitted, and here, different portions will be mainly described. Note that duplicate descriptions thereof will be omitted in the following respective embodiments.

Namely, the present embodiment is a modified example of the first embodiment, and is configured such that the screen display unit 34 displays icons ic1x to ic3x whose sizes are varied so as to be inversely proportional to the distances between the display apparatus 30 and the peripheral objects 1 to 3. For example, the icons ic1x and ic3x which are located at closer positions are displayed so as to be larger, and on the other hand, the icon ic2x which is located at a farther position is displayed so as to be small.

Such a configuration can be realized due to metadata in which a relationship between a distance with the display apparatus 30 and a size of an icon is described being prepared.

In accordance with such a configuration, in addition to the operation and effects of the first embodiment, the places at which the peripheral objects 1 to 3 are placed can be three-dimensionally expressed, and at the same time, operations of the devices which are more deeply related thereto, i.e., in the vicinity thereof can be made easier for a user. Further, in a case in which the antenna array 32 has a characteristic in which a three-dimensional relative position can be detected, the characteristic can be made the best use.

To complementarily describe, the recognition of the positions of the peripheral objects 1 to 3 by the antenna array 32 is not limited to being on plane. When the antenna array 32 can detect three-dimensional relative positions, provided that the three-dimensional relative positions are displayed on the screen display unit 34, further convenience can be provided to users. Further, when the distances are expressed by the sizes of the icons ic1x to ic3x, provided that the antenna array 32 emits a radio wave in the vertical direction which is on the opposite side with respect to the screen display unit 34, the azimuths of the peripheral objects 1 to 3 which are located at the side opposite to the screen display unit 34 can be detected.

### Third Embodiment

FIG. 11 is a typical diagram showing an appearance of a screen display unit of a display apparatus according to a third embodiment of the present invention. Namely, the present embodiment is a modified example of the first embodiment, and has a three-dimensional shaped (e.g.: hemispherical) screen display unit 34a in place of the plane screen display unit 34. In accordance therewith, as the antenna array 32, an antenna array which has respective motors connected to the respective antennas, and which has antenna adjusting function adjusting the directions of the respective antennas by driving the respective motors is used.

In the display apparatus 30, a function of estimating the three dimensional azimuth is added to the peripheral object azimuth estimating unit 41 such that the icons ic1 to ic3 denoting the peripheral objects 1 to 3 can be displayed on the screen display unit 34a having a three dimensional hemispherical shape on the basis of the radio signals received by the respective antennas whose directions have been adjusted.

In accordance therewith, the screen display unit 34a displays the icons ic1 to ic3 at the azimuths at which the peripheral objects 1 to 3 are discovered with respect to the peripheral objects 1 to 3 located at the upper side from the reference plane with the cross-section of the hemisphere being as a reference plane.

For example, provided that this display apparatus is installed at the center of a table in a meeting room or the like, when other apparatuses which are installed in or carried into the meeting room are controlled, it is possible to provide an interface which is easily understandable for all of the users who are surrounding the periphery thereof. As the other apparatuses to be controlled, for example, there are notebook model personal computers, projectors, lighting systems, sound systems, automatic curtains, or the like.

In accordance with a configuration as described above, in addition to the operation and effects of the first embodiment, the directions or the positions of the three-dimensionally spatial peripheral objects can be displayed, and an interface which is easily understandable for users can be provided.

Note that the present embodiment may be modified as follows. For example, it may be modified such that, separately from the three-dimensional shaped screen display unit 34a displaying the icons ic1 to ic3, the plane screen display unit 34 displaying a working screen is used. It may be modified such that a display apparatus which can display three-dimensional images (manufactured by Toshiba Corporation) is used as the screen display unit 34a, and the icons ic1 to ic3 of the peripheral objects 1 to 3 are displayed at positions which are closer to the actual relatively positional relationship.

### Fourth Embodiment

Next, several embodiments in the case in which the first embodiment described above is applied to various systems will be described. However, portions which are common to the following respective embodiments will be simply described in advance thereof.

Currently, under the leadership of the American MIT auto ID center, the engineering development and the system revision which are for attaching radio tags to various things have been made to progress. The following respective embodiments show cases in which communication with respect to the peripheral objects is carried out by the display apparatus 30 in the world in which radio tags are attached to various peripheral objects.

The respective embodiments are broadly divided into the examples of [1] to [3].

[1] An example of the communication with a writable radio tag tg (e.g.: an air conditioner).

[2] An example in which the peripheral objects associated with the radio tags tg are peripheral objects which can communicate through a network, and a request of a user is satisfied by the communication (e.g.: a personal computer, an automobile).

[3] An example in which the peripheral objects associated with the radio tags tg do not have an communication functions and computing functions, and a request of a user is satisfied by accessing to the peripheral object representative server 10 in which related information on the peripheral objects have been stored (e.g.: clothes, DVDs).

A common point to the three examples is the flow up to the start of the operations. First, a user has some request, and has the display apparatus 30 for satisfying the request. As this request, for example, there are a wish to cool a room, a wish to carry data over the computer and display it, a wish to know the information on the producer of the movie recorded on this DVD, or the like.

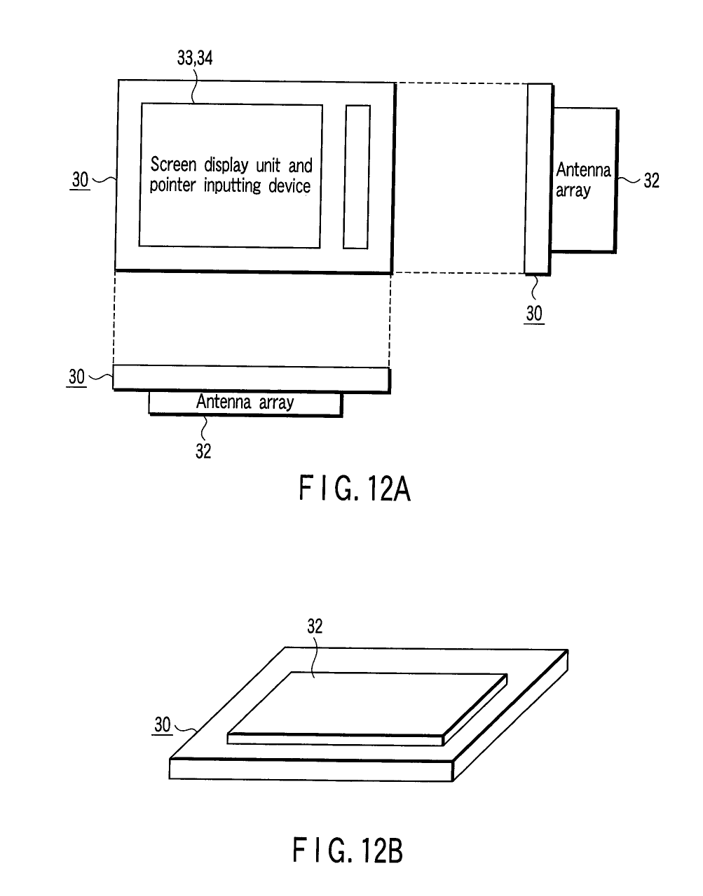

Here, the display apparatus 30 is configured as described above. As the examples of the display apparatus 30, the plan view and the side view are shown in FIG. 12A, and the outside drawing as seen from the rear face is shown in FIG. 12B. As the display apparatus 30, for example, a display apparatus in which a tablet PC (e.g.: Dynabook SS3500 manufactured by Toshiba Corporation, or the like) is enlarged can be used.

The user carries the display apparatus 30 to a place close to the peripheral objects. At this time, the display apparatus 30 detects radio signals output from the radio tags tg of the peripheral objects by the antenna array 32, and acquires the peripheral object Ids and the azimuths of the peripheral objects.

The display apparatus 30 displays the icons ic of the peripheral objects so as to be made to correspond to the azimuths of the peripheral objects. At this stage, because the contents of the peripheral objects are obscure, the icons ic are common icons ic′ denoting the “unknown peripheral objects”.

The display apparatus 30 inputs the peripheral object Ids to the metadata acquiring unit 43, and acquires metadata corresponding to the peripheral object Ids by the metadata acquiring unit 43.

At this stage, the display apparatus 30 acquires the icon drawings by utilizing the metadata, and displays the icons ic so as to correspond to the drawings. The user can easily verify the displayed icons ic from both of the bearings and the drawings.

Thereafter, the user operates the display apparatus 30 in accordance with a request. The display apparatus 30 executes an operation at the time of detecting signals described in the metadata in accordance with the operation by the user. The above descriptions are the common contents.

However, as the operation at the time of detecting signals, because the contents different from each other are described in the metadata for each peripheral object, processings different for each metadata are executed by the display apparatus 30.

Accordingly, with respect to the following respective embodiments, an operation at the time of detecting signals which is different for each peripheral object will be mainly described. First, a fourth embodiment of the present invention in which an air conditioning device is used as a peripheral object will be described.

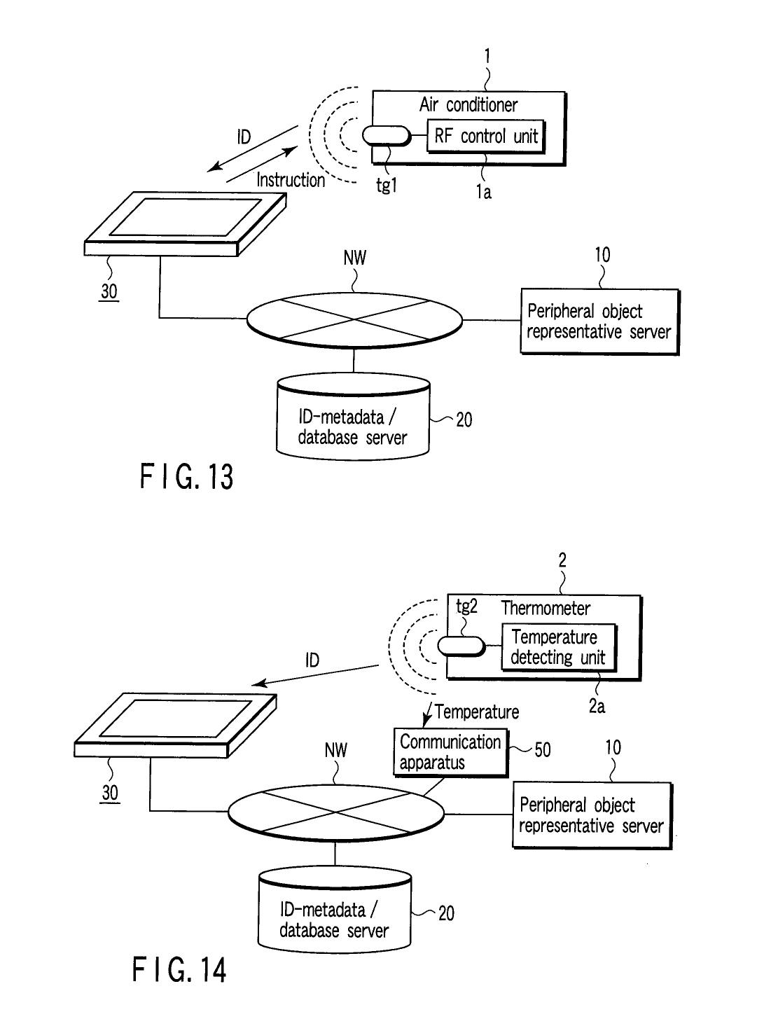

FIG. 13 is a typical diagram showing a configuration of a network communication system according to the fourth embodiment of the present invention. As illustrated, the peripheral object 1 is an air conditioning device (hereinafter, called an air conditioner) 1.

Here, the metadata corresponding to the air conditioner 1 includes at least descriptions of a command needed for controlling RF (Radio Frequency) of the air conditioner 1, a form of a value to be transmitted, or the like. As the RF control, there is an example of an RF control by Bluetooth or the like, an example of an RF control by an operation of writing a radio tag, or the like. When the display apparatus 30 has an infrared ray transmitting and receiving device, infrared ray control can be used.

Further, the antenna array 32 can transmit and receive radio signals. However, it is not limited thereto, the antenna array 32 may be able to receive radio signals, and the network interface 35 may be able to transmit and receive radio signals.

Next, operations of the network communication system configured as described above will be described. Note that the operations from that the display apparatus 30 identifies the air conditioner 1 up to that an icon ic1 of the air conditioner 1 is displayed are the same as described above.

Now, the display apparatus 30 is displaying the icon ic1 of the air conditioner 1. At this time, because the air conditioner 1 is controlled with the intention to reduce the room temperature, the user operates the icon ic1 by, for example, double-clicking.

On the display apparatus 30, the description of the metadata corresponding to the double-click operation is read by the double-click operation, and is executed by the metadata interpretation executing unit 44. As this contents to be executed, in the case of the air conditioner 1, an operation is appropriate in which a user interface imitating a control panel is prepared, and is displayed on the display apparatus 30. This user interface corresponds to the pointer inputting device 33 described above.

The user inputs, for example, an operation of reducing the room temperature 1° C. to the user interface. The user interface inputs a corresponding operational signal to the peripheral object icon control unit 42.

The peripheral object icon control unit 42 transmits an operational identifier and metadata corresponding to the operational signal to the metadata interpretation executing unit 44. The metadata interpretation executing unit 44 executes processing for reflecting this operation to the air conditioner 1. To describe concretely, a command needed for controlling an RF of the air conditioner (a temperature setting value is reduced) and a form of a value to be transmitted (1° C.) are acquired from the metadata, and the command and the value are transmitted to the air conditioner 1 via the antenna array 32.

In the air conditioner 1, when the command and the value are received by the radio tag tg 1, an RF control unit 1a executes processing of reducing the room temperature in accordance with the received contents.

As described above, in accordance with the present embodiment, in addition to the operation and effects of the first embodiment, the peripheral object 1 (e.g.: the air conditioner 1) whose RF is controlled can be controlled by transmitting and receiving a radio signal between the radio tag tg1. Here, the example of the air conditioner 1 was described. However, it is not limited thereto, it goes without saying that any product whose RF can be controlled (which can be controlled by remote control), such as a television device, a video recorder, a radio-cassette recorder, or the like can be achieved in the same way.

In the present embodiment, the user interface is displayed by a double-click operation onto the icon ic1, and an operation of reducing the room temperature is input to the user interface. However, it is not limited thereto, the description of the operation at the time of detecting signals in the metadata may be arbitrarily modified such that the operation of reducing the room temperature is executed directly by accessing to the menu by metaclicking without being passed through the user interface.

### Fifth Embodiment

FIG. 14 is a typical diagram showing a configuration of a network communication system according to a fifth embodiment of the present invention. As illustrated, a thermometer 2 serving as the peripheral object 2 is provided thereto, and a communication apparatus 50 for acquiring a temperature from the thermometer 2 is connected to the network NW.

Here, the thermometer 2 is a thermometer in which a radio tag tg 2 is added to a temperature detecting unit 2a having an independent communication mechanism, and as the temperature detecting unit 2a, for example, HotNode (trade name) manufactured by InternetNode Inc. can be used. HotNode has a thermometer, an information processing device, and a network interface, and a state of the thermometer can be acquired through the network interface. The thermometer 2 in the present embodiment is a thermometer in which the radio tag tg 2 is added to the temperature detecting unit 2a which can carry out this type of communication.

In accordance therewith, as shown in FIG. 2, the metadata corresponding to the thermometer 2 includes the description of the effect that characters are imposed upon the icon drawing acquiring method. The metadata includes the description of the effect that, in order to update the characters (a current temperature) to be imposed, communication is periodically carried out with the thermometer 2 via the network NW by predetermined communication procedure, and a current temperature is acquired, in an operation at the time of detecting signals.

The communication apparatus 50 is an interface device which is capable of radio communication for communicating with the thermometer 2 via the network NW.

Next, operations of the network communication system configured as described above will be described. Note that the operations from that the display apparatus 30 identifies the thermometer 2 up to that an icon ic2 of the thermometer 2 is displayed are the same as described above.

Now, the display apparatus 30 is displaying the icon ic2 of the thermometer 2, and a current temperature is being imposed upon the icon ic2.

The display apparatus 30 periodically communicates with the thermometer 2 via the network NW and the communication apparatus 50 by predetermined communication procedure on the basis of the metadata of the thermometer 2, and current temperature data is acquired. The temperature data is displayed so as to be imposed upon the icon ic2. In accordance therewith, the display apparatus 30 can display information on the thermometer 2 and the like which are in the circumference without any operation by a user.

As described above, in accordance with the present embodiment, in addition to the operation and effects of the first embodiment, due to communication being carried out via the network NW with the peripheral object 2 (e.g.: the thermometer 2) which is capable of radio communication, the information on the peripheral object 2 can be acquired. Note that, here, the example of thermometer 2 was described. However, it is not limited thereto, it goes without saying that any product which is capable of transmitting data, such as a measuring device except for a temperature measuring device, an image pickup device, or the like, can be achieved in the same way.

### Sixth Embodiment

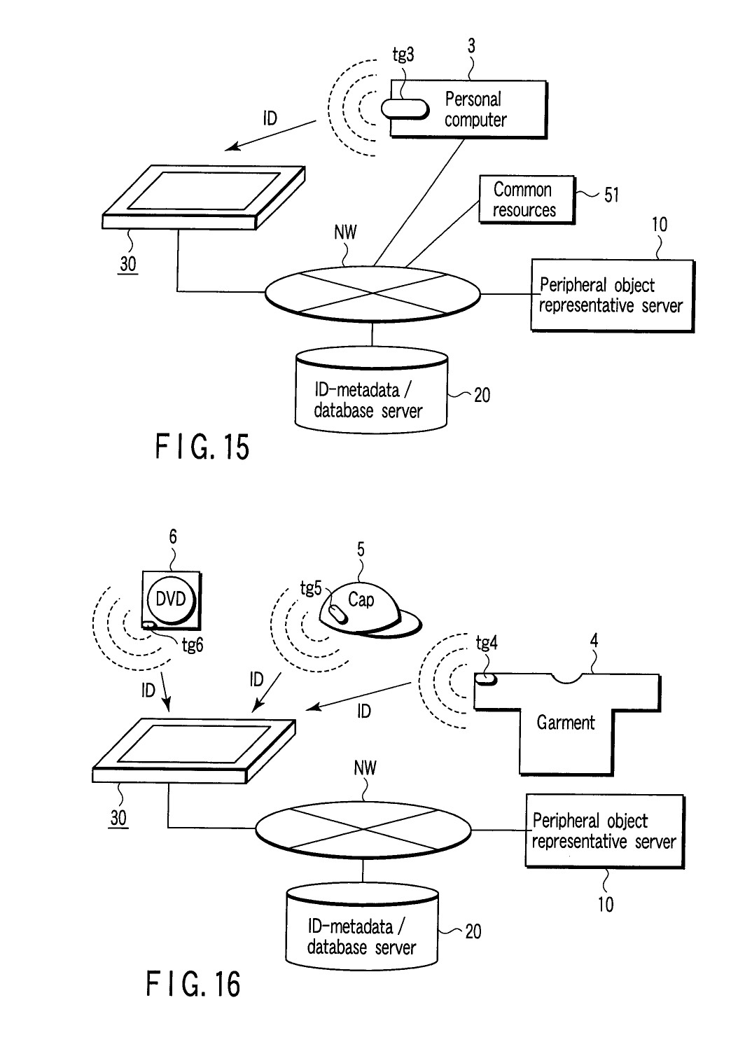

FIG. 15 is a typical diagram showing a configuration of a network communication system according to a sixth embodiment of the present invention. As illustrated, a personal computer 3 serving as the peripheral object 3 is provided thereto, and common resources 51 such as a storage device for a shared folder is connected to the network NW.

In accordance therewith, the metadata corresponding to the personal computer 3 includes the description of the effect that folders including the common resources 51 are mounted (peripheral devices are displayed so as to be able to be operated) with respect to a double-click operation onto the icon ic3. The metadata includes the description of the effect that, with respect to an operation at the time of being dropped for the icon ic3, when the dropped icon ic3 denotes a file, the file is written into the folder of the common resources 51.

Next, operations of the network communication system configured as described above will be described. Note that the operations from that the display apparatus 30 identifies the personal computer 3 up to that an icon ic3 of the personal computer 3 is displayed are the same as described above.

Now, the display apparatus 30 is displaying the icon ic3 of the personal computer 3. At this time, for example, the user operates the icon ic3 by double-clicking, with the intention of using the file of the common resources.

The display apparatus 30 opens and displays the user interface in accordance with the double-click operation. Next, on the display apparatus 30, when a shared folder existing in the user interface is designated by an operation of the user, the user interface of the shared folder in the common resources 51 can be opened and displayed, or the file can be recorded in the shared folder by dragging the file onto the icon ic3.

In both cases, it is possible to read/write the respective files in the shared folder due to the shared folder being designated. In the same way, the files can be conveniently exchanged.

As described above, in accordance with the present embodiment, in addition to the operation and effects of the first embodiment, due to the icon ic3 of the peripheral object 3 being operated, the object (common resources 51) on the network NW can be utilized. Here, the common resources 51 including the share folder can be utilized. In the same way, the files can be conveniently exchanged.

Note that the present embodiment can be applied as follows. As an applied example of the operation at the time of being dropped in the metadata, the description of the effect that the dropped document is printed or transmitted is included in the metadata of the peripheral objects such as a printer, a facsimile, or the like. In addition thereto, the communication procedure and abilities (color, monochrome, both-side printing, or the like) for printing or transmitting are described in the metadata. In accordance therewith, the user can utilize the printer or the like without being conscious of the specification (communication procedure and abilities) of the printer or the like.

### Seventh Embodiment

FIG. 16 is a typical diagram showing a configuration of a network communication system according to a seventh embodiment of the present invention. As illustrated, the peripheral objects 4 to 6 are a garment 4, a cap 5, and a video software DVD 6. The garment 4, the cap 5, and the video software DVD 6 are the examples in the case in which the peripheral objects do not have any communication function and computing function.

Here, respective metadata corresponding to the garment 4, the cap 5, and the video software DVD 6 include the description of the effect that respective related information (webpages or the like) on the garment 4, the cap 5, and the video software DVD 6 are read from the peripheral object representative server 10 in accordance with, for example, a double-click operation.

Next, operations of the network communication system configured as described above will be described. Note that the operations from that the display apparatus 30 identifies the garment 4, the cap 5, and the video software DVD 6 up to that respective icons ic4 to ic6 thereof are displayed are the same as described above.

Now, the display apparatus 30 is displaying the respective icons ic4 to ic6 of the garment 4, the cap 5, and the video software DVD 6. At this time, the user operates the icon ic6, for example, by double-clicking, with the intention of knowing the summary of the video software DVD 6.

The display apparatus 30 starts an unillustrated browser in accordance with the double-click operation, and accesses to the peripheral object representative server 10 which administers the webpage of the corresponding video software DVD 6, and displays the corresponding webpage. Further, when a software for an information processing device is made to be a peripheral object in place of the video software DVD, it can be configured such that a user registration procedure, a license approval procedure, or the like can be generated.

As described above, in accordance with the present embodiment, in addition to the operation and effects of the first embodiment, with respect to the peripheral objects 4 to 6 (the garment 4, the cap 5, and the video software DVD 6) without any communication function and computing function, the icons ic4 to ic6 can be displayed on the display apparatus 30, and the related information thereon can be acquired.

To describe in detail, the present embodiment is an example in which, even if the peripheral objects do not have any communication function, metadata can be acquired by the radio tags tg4 to tg6, and the peripheral object representative server 10 can be accessed. As a modified example, the metadata of the peripheral objects 4 to 6 are divided into public metadata and private metadata, and a usage history or the like can be written into/read from the private metadata. Note that the public metadata is data which can be read from a third party. The private metadata is data on which only a specific individual can read/write. The usage history is, for example, in a case of a garment, a history of washing and/or wearing.

### Eighth Embodiment

Next, as an eighth embodiment of the present invention, several methods for acquiring metadata which can be applied to the network communication system will be described.

Metadata is stored in the dedicated ID-metadata/database server 20 in principle. The ID-metadata/database server 20 is disposed so as to be distributed as a plurality of devices. At the same time, for example, by using a mechanism such as a distributed hash table (DHT; Distributed Hash Table) or the like, the peripheral object IDs are associated with the respective ID-metadata/database servers 20.

In this case, the display apparatus 30 must have two-stage configured metadata acquiring unit 43. The two-stage configuration is formed from a configuration in which network addresses of the respective ID-metadata/database servers 20 are acquired by using the distributed hash table form the peripheral object IDs, and a configuration in which metadata are acquired from the respective ID-metadata/database servers 20.

Each ID-metadata/database server 20 manages data of an arbitrary group such as, for example, a company, a family, a local government, or the like. It is preferable that the ID-metadata/database server 20 and the group are in some mutual credit relationship. Further, the ID-metadata/database server 20 has a function of delegation of authority such as a DNS (Domain Name Server), and with respect to a specific small group included in the group, the data thereof can be transferred to another database server. By the function of delegation of authority, it is possible for the peripheral object to maintain metadata. In this case, the peripheral object must have a communication function and a database server function.

Note that, in the case of using a DNS, the display apparatus 30 must have another two-stage configured metadata acquiring unit 43. The other two-stage configured is formed from a configuration in which the peripheral object IDs are converted into the names which can use a DNS, and network addresses of the ID-metadata/database servers 20 are acquired from the peripheral object IDs by using the DNS, and a configuration in which metadata are acquired from the respective ID-metadata/database servers 20.

Further, when the peripheral object IDs are associated with the ID-metadata/database servers 20 in a smaller group in a family or the like, association may be carried out (metadata may be acquired) due to a request being broadcast to the ID-metadata/database servers 20, not on a DHT or a DNS, but on the same physical network (Ethernet segment).

Note that the metadata acquired as described above is preferably prepared by a manufacturer of a peripheral object. However, it is preferable that the metadata can be updated by an owner of the peripheral object. When the metadata is updated, it is recommended that the owner of the peripheral object be delegated with the authority from the database server, and update the metadata.

In this case, it is recommended that an individual or an arbitrary group prepare his/her or their own ID-metadata/database server 20, and the display apparatus 30 have a function of updating the metadata in his/her or their own ID-metadata/database server 20 so as to be correspond to a DHT or a DNS by an operation of an individual or an arbitrary group.

### Ninth Embodiment

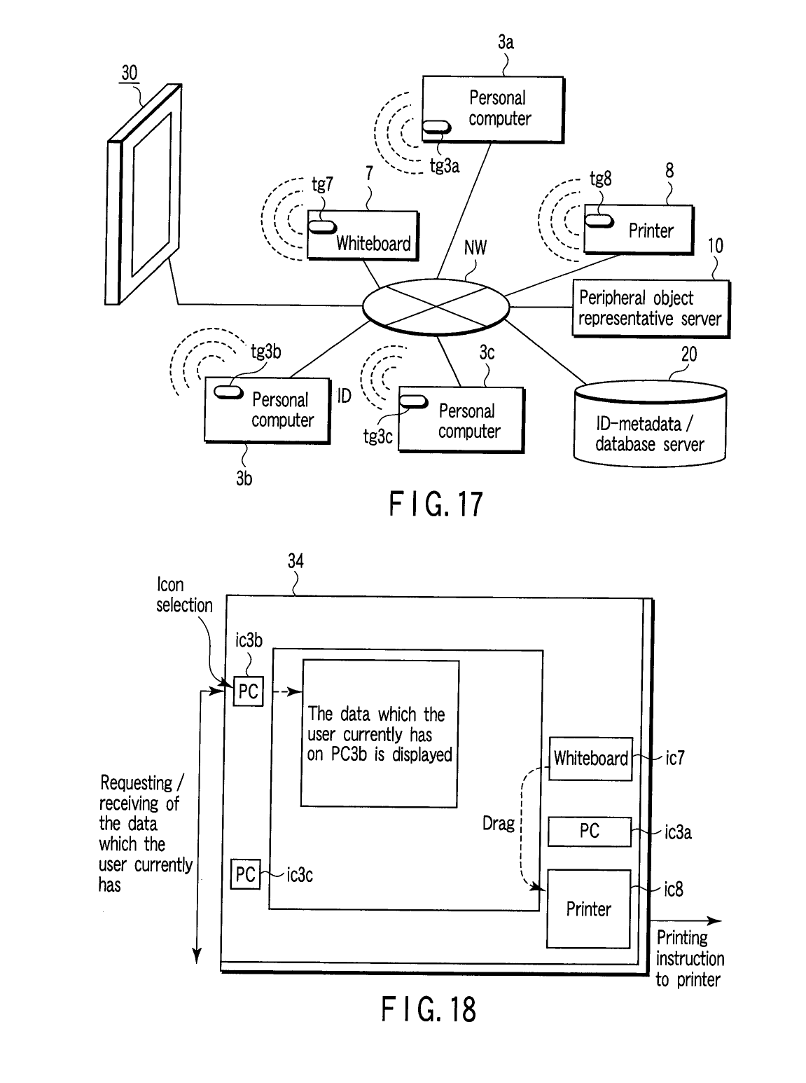

FIG. 17 is a typical diagram showing a configuration of a network communication system according to a ninth embodiment of the present invention. As illustrated, it is an example in which personal computers 3a to 3c, a white board 7, and a printer 8 serving as the peripheral objects are connected to the network NW.

The personal computers 3a to 3c, the white board 7, the printer 8, and the display apparatus 30 configure a meeting room with a situation adaptable screen. The personal computers 3a to 3c are supposed to be notebook model personal computers. As the display apparatus 30, if it can detect an icon operation, an arbitrary device such as a screen, a projector, or the like can be used.

Here, the metadata corresponding to each of the personal computers 3a to 3c includes the description of the effect that a display screen of the corresponding personal computer 3a is displayed on the display apparatus 30, for example, with respect to an operation of selecting the icons 3a to 3c.

Metadata corresponding to the white board 7 includes the description of the effect that, for example, with respect to an operation of dropping the icon ic7, information on the whiteboard 7 is transmitted to equipment which is the destination to be dropped. In the same way, metadata corresponding to the printer 8 includes the description of the effect that, for example, with respect to an operation of dropping the icon ic8, information transmitted from the dropping is received and printed.

Next, operations of the network communication system configured as described above will be described. Note that the operations from that the display apparatus 30 identifies the personal computers (PCs) 3a to 3c, the white board 7, and the printer 8 up to that respective icons ic3 to ic3c, ic7, and ic8 are displayed are the same as described above.

Now, the display apparatus 30 is displaying the respective icons ic3 to ic3c, ic7, and ic8. At this time, for example, with the intention of showing the display screen of the personal computer 3b to everyone, as shown in FIG. 18, the user operates to an icon ic3b on the display apparatus 30 by selecting.

The display apparatus 30 accesses to the personal computer 3b in accordance with a selecting operation, and requests data of the display screen, and displays the display screen of the personal computer 3b, for example, in a window.

In accordance therewith, in a meeting in which respective persons bring notebook model personal computers (3a to 3c), the respective persons can easily show data on the personal computers to everyone.

Further, for example, it is assumed that the user carries out an operation of being dropped in which the icon ic7 is dragged and dropped upon the icon ic8. Note that this operation may be modified such that the ic8 is dropped upon the ic7.

In both cases, the display apparatus 30 controls the whiteboard 7 and the printer as described in the metadata by the operation of being dropped, and the information on the whiteboard 7 can be output to the printer 8.

As described above, in accordance with the present embodiment, in addition to the operation and effects of the first embodiment, with respect to the peripheral objects 3a to 3c, 7, and 8 (the personal computers 3a to 3c, the whiteboard 7, and the printer 8) with communication functions as well, icons ic3a to ic3c, ic7, and ic8 are displayed on the display apparatus 30, and the control can be executed in accordance with an icon operation.

Note that the present embodiment can be modified as in the following [9-1] to [9-3] by modifying the descriptions of the metadata.

[9-1] An operation in which the information on the white board 7 is converted into a predetermined picture format, and is placed in a file server on the network NW can be carried out by a double-click operation onto the icon ic7 of the whiteboard 7.

Here, the file server of the peripheral object exists at a remote position. However, this operation can be achieved due to the icon icf of the file server being displayed on the display apparatus 30, and due to the icon ic7 of the whiteboard 7 being dragged onto the icon icf of the file server.

[9-2] A table placed in the meeting room may be served as the display apparatus 30. In this case, a plurality of peripheral object icons on the display apparatus 30 can be operated by a plurality of persons. Further, the peripheral object icons are moved in accordance with the movement of the table which is the display apparatus 30, and the peripheral objects can be more intuitively selected and operated.

[9-2′] The table which is the display apparatus 30 is not moved, and the peripheral object icons on the display apparatus 30 may be moved so as to follow the movements of the peripheral objects. In this case, a temporary change of the layout in the meeting room, an operation with respect to the peripheral objects which the attendees have, or the like, can be easily executed.

Note that, in the modified examples [9-1] and [9-2′], the frequencies of movements of the peripheral objects or the like are different. Therefore, when the movements in the peripheral objects are little, an interval of transmitting radio signals by the radio tags tg may be made long in order to suppress the power consumption.

[9-3] Not only the peripheral objects are displayed on the display apparatus 30 on the spot, but also the azimuths of the peripheral objects are transmitted to a remote location, and a remote meeting with highly promoted presence can be realized. Note that it is not limited to a meeting, and the example can be applied to various applications having virtual reality common to a remote location. Additionally, due to the peripheral objects existing at the remote locations being displayed as the peripheral object icons, and operated, the peripheral objects can be operated remotely.

### Tenth Embodiment

Next, as a tenth embodiment of the present invention, the effect that the intended users of the network communication system is broad will be described, and moreover, several examples of preferred network communication systems will be described.

As the users, not only the youth and the physically normal persons, but also persons who can move but only little portion of the bodies, for example, because of having lesions in their bodies are considered.

For example, in a case of a user who can move but only some portion of his/her body, it is difficult to let a caregiver know a request. When the caregiver is not nearby, it is extremely difficult to operate external equipment or the like in order to satisfy the request of the user. This is not limited to physically handicapped persons, but is in the same way as the aged or the like.

The user can easily let the caregiver know the intention by pointing to the display apparatus 30 on which the peripheral object icons are displayed. At this time, for example, in the case in which only the tip of the tongue or the like can be moved, it is possible to operate the pointer with the tip of the tongue. At this time, there is no need for the peripheral objects to have a communication function and a calculating function.

Further, the user can carry out an operation with respect to the peripheral objects by a dragging operation, a dropping operation, and a click operation. Therefore, the user can handle with the peripheral objects even when the caregiver is not nearby. In accordance therewith, a burden on the caregiver is reduced. Further, what a person to be nursed operates equipment or material bodies which are in the circumference or reads the related information for himself/herself improves the quality of life of the person to be nursed himself/herself, which leads to obtaining a sense of accomplishment and a feeling of satisfaction. In accordance with these features, the present invention is useful in a nursing industry in an aging society.

Note that, when operations with respect to the peripheral objects are carried out, and in a case in which a plurality of operations are possible, the plurality of operations are displayed on the display apparatus 30, and the users may be urged to select those.

As this selection, various techniques can be considered in accordance with a type of a lesion or the like. For example, when a pointer is placed on a peripheral object icon for a given time, a menu is displayed in the circumference of the peripheral object icon, and by selecting the menu, a corresponding operation can be executed by only a pointer operation without any click operation. In this way, when various types of input interface devices can be supposed, the display apparatus 30 may discover an input interface device in accordance with a technique which will be described hereinafter.

Next, in consideration of the above-described circumstances, the tenth embodiment of the present invention will be described.

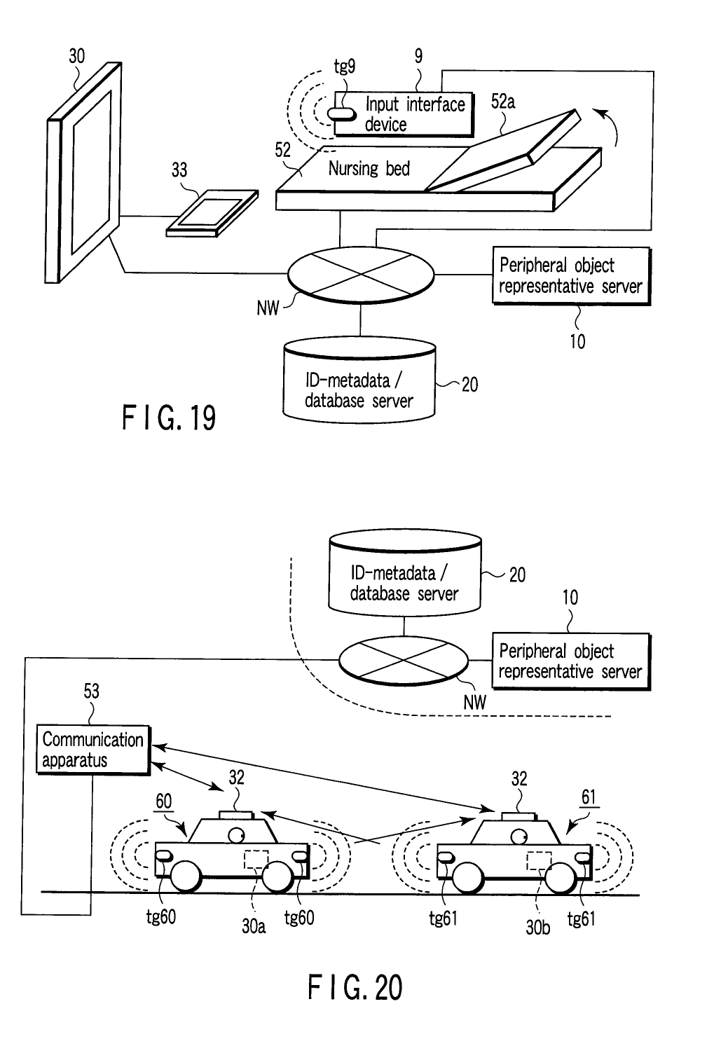

FIG. 19 is a typical diagram showing a configuration of a network communication system according to the tenth embodiment of the present invention. As illustrated, it is an example in which an input interface device 9 and a nursing bed 52 serving as the peripheral objects are connected to the network NW.

Here, the input interface device 9 has a function of inputting an operational signal in accordance with a radio wave, infrared rays, or wire communication, or the like, with respect to the pointer inputting device 33 of the display apparatus 30. Note that, here, with the physically handicapped persons or the aged, or the like being as the intended users, the input interface device 9 inputs an operational signal corresponding to a movement of a portion (e.g.: the tip of the tongue, the lids, or the like) of the body which the user can move. However, it is not limited thereto, the input interface device 9 may be realized as a general remote control device.

Further, accompanying the above description, metadata of the input interface device 9 includes the description of the effect that the operational signal output from the input interface device 9 is input to the pointer inputting device 33.

The nursing bed 52 has a function of lifting up and laying down a backrest plate 52a in accordance with a control instruction received from the network NW.

Next, operations of the network communication system configured as described above will be described. Note that the operations from that the display apparatus 30 identifies the input interface device 9 and the nursing bed 52 up to that respective icons ic9 and ic52 are displayed are the same as described above.

Now, the display apparatus 30 is displaying the respective icons ic9 and ic52. At this time, it is assumed that the input interface device 9 outputs an operational signal due to an operation by the user.

When the operational signal is received, the display apparatus 30 inputs the operational signal to the pointer inputting device 33 on the basis of the metadata, and thereafter, controls the nursing bed.

As described above, in accordance with the present embodiment, even when the peripheral object 9 is operated without operating the icons displayed on the display apparatus 30, the operation and effects which are the same as in the first embodiment can be obtained in accordance with the description in the metadata.

Note that, in the present embodiment, the example in which the display apparatus 30 identifies the input interface device 9 was described. However, it is not limited thereto, it may be configured such that the input interface device 9 identifies the display apparatus 30, and acquires the metadata of the display apparatus 30, and the input interface device 9 interprets and executes the specification of the inputs with respect to the pointer inputting device 33 in the metadata, and the input interface device 9 inputs the output to the pointer inputting device 33.

Further, in the present embodiment, the example in which the nursing bed is lifted up and laid down was described. However, it is not limited thereto, and the present embodiment can be applied to an arbitrary control such as operations of a radio and a television, a change of temperature setting in air conditioning, or the like. Further, in accordance with a description in the metadata, various types of peripheral objects can be operated by only pointer operations.

Conventionally, caregivers are needed for any cases of such operations. However, in accordance with the present embodiment, it is possible for a user to easily execute a desired operation without a caregiver.

Further, in a case in which a user lets a caregiver know a garment which the user wishes to put on, or the user wishes to be dressed in, or the like, material bodies without any communication and computing ability can be handled in the same way. In such a case, the peripheral objects can be handled by utilizing the peripheral object representative server 10.

Note that, in the case of the present embodiment, because of using electromagnetic wave signals as radio signals, the possibility of malfunction in medical equipment such as a pacemaker or the like cannot be negated. Therefore, in a case in which the present embodiment is executed in a hospital, it is preferable that, not electromagnetic wave signals, but infrared signals are used.

### Eleventh Embodiment

FIG. 20 is a typical diagram showing a configuration of a network communication system according to an eleventh embodiment of the present invention. As illustrated, it is an example in which display apparatuses 30a and 30b installed in automobiles 60 and 61 serving as the peripheral objects are connected to the network NW via a communication apparatus 53.

Here, the automobiles 60 and 61 respectively have the display apparatuses 30a and 30b and radio tags tg60 and tg61.

The antenna arrays 32 of the display apparatuses 30a and 30b have functions of transmitting and receiving radio signals in the present embodiment, and have outputs which can exchange radio messages at a distance between automobiles which can ensure safety. This is in the same way as the radio tags tg60 and tg61.

The antenna arrays 32 may be installed at arbitrary portions, if those are portions at which a radio wave can be easily transmitted and received, such as the top portions, the bottom portions, or the front face portions, the rear face portions, the like of the automobiles 60 and 61. This is in the same way as the radio tags tg60 and tg61.

However, the radio tags tg60 and tg61 are not limited to one for each of the automobiles 60 and 61, and from the standpoint of suppressing the blocking effect of electromagnetic waves due to the vehicle body to a minimum, a plurality of radio tags tg60 and tg61 may be provided to each of the automobiles 60 and 61. For example, two radio tags tg60 may be attached to the positions of the front and rear number plates. In this case, because the two radio tags tg60 denote a same peripheral object ID, there is the possibility in which a plurality of azimuths with respect to a peripheral object are generated. In this case, an azimuth into which both of the azimuths are complemented may be calculated by the peripheral object azimuth estimating unit 41. Note that a number of an automobile may be used as a peripheral object ID.

Further, metadata of the display apparatuses 30a and 30b include the description of the effect that, in accordance with an operation of the icons of the other automobiles 60 and 61, information is transmitted to the automobiles 60 and 61 corresponding to the icon. The information to be transmitted may be voice information or picture information, or both of those.

Next, operations of the network communication system configured as described above will be described. Note that the operations from that the display apparatuses 30a and 30b identify the other automobiles 60 and 61 up to that icons ic61 and ic60 are displayed are the same as described above.

Now, for example, the display apparatus 30a of the automobile 60 displays the icon ic61 of the automobile 61. At this time, by displaying the icon such that the traveling direction of the automobile is at the top side, a user can intuitively grasp the positional relationship between the peripheral object 61 and the automobile 60 which he/she is driving. However, it may be arbitrarily changed what portion on the display apparatus 30 is allocated to which direction. In this case, it can be considered that it is changed due to an intention of the user, or it is changed due to the direction in which the automobile is traveling being changed.

When the user carries out passing, a right/left turn, or the like, the user can immediately grasp whether or not another automobile 61 exists in a direction in which the user is going to move from now on by looking at the display apparatus 30a. Therefore, the present invention is a factor for judging safety at the time of driving.

Further, by carrying out a pointer inputting operation (hereinafter, called a tap operation) by a click operation or softly touching with a finger with respect to the icon ic61 of the other automobile 61, or due to an instruction with voice, the display apparatus 30a acquires metadata from the network NW via the communication apparatus 53, and operations included in the metadata can be executed. Note that when a plurality of operations are included in the metadata, an arbitrary operation may be selected and executed by a click, a direct tap operation with a finger, or an instruction with voice.

As such an operation, for example, it can be assumed that arbitrary information, such as warning against the automobile 61 who is going to interrupt, a danger warning, an interruption warning, gratitude for yielding, is displayed on the display apparatus 30b of an opposite party. Further, voice communication with audio or picture such as a chat can be carried out.

As described above, in accordance with the present embodiment, in addition to the operation and effects of the first embodiment, communication between the display apparatuses 30a and 30b can be achieved. Further, due to the display apparatuses 30a and 30b being installed in the automobiles 60 and 61, communication between the automobiles can be achieved.

Note that techniques described in the above-described respective embodiments can be stored as programs which can be executed by computers in storage media such as a magnetic disk (a Floppy® disk, a hard disk, or the like), an optical disk (a CD-ROM, a DVD, or the like), an magneto-optical disk (MO), a semiconductor memory, or the like, and can be distributed.

As the storage media, if it is a storage medium in which the programs can be stored, and which can be read by computers, the storage system may be in any format. Some of the respective processings for realizing the present embodiments may be executed by an OS (operating system) which operates the computer on the basis of instructions from the program installed in the computer from the storage medium, middleware such as a database management software, a network software, or the like.

The storage medium in the present invention is not limited to a medium independent of the computer, and storage media which have downloaded and stored, or temporarily stored programs transmitted through a LAN, the Internet, or the like are included. The storage medium is not limited to one, and the case in which the processings in the present embodiment are executed through a plurality of storage media is included in the storage media in the present invention, and the medium configuration may be any configuration.

Note that, the computer in the present invention executes the respective processings in the present embodiment on the basis of a program stored in a storage medium, and may be any configuration of an apparatus formed from one such as a personal computer or the like, a system in which a plurality of devices are connected to a network, and the like. The computer in the present invention is not limited to a personal computer, and includes an arithmetic processing unit included in an information processing device, a micro-computer, or the like, and is the general term for devices and apparatuses which can realize the functions of the present invention by the programs.

Note that the present invention is not limited to the above-described embodiments as are, and structural requirements can be modified and materialized within a range which does not deviate from the gist of the present invention at the practical phase. Further, various inventions can be formed due to the plurality of structural requirements which have been disclosed in the above-described embodiments being appropriately combined. For example, several structural requirements may be eliminated from all of the structural requirements shown in the embodiments. Moreover, structural requirements over different embodiments may be appropriately combined.

What is claimed is:

1. A server apparatus which communicates via a network with a peripheral object communication apparatus;
a metadata storage device configured to store metadata in which displaying information and a communication system are described for each peripheral object which outputs a radio signal to circumference;
a radio signal receiving device configured to receive a radio signal output from the peripheral object, and to transmit the obtained received signal;
an object identifying device configured to identify the peripheral object on the basis of the received signal;
an azimuth detecting device configured to detect an azimuth of the peripheral object on the basis of the received signal;
a metadata acquiring device configured to acquire metadata of the identified peripheral object from the storage apparatus;
an icon displaying device configured to display an icon corresponding to the peripheral object at a position corresponding to the azimuth in a screen on the basis of displaying information in the metadata; and
a communication device configured to execute communication corresponding to the peripheral object on the basis of a communication system described in the metadata corresponding to the icon when the icon is selected, the server apparatus comprising:
a related information storage device configured to store related information for each peripheral object in advance; and
an information replying device configured to reply corresponding related information in the related information storage device to the peripheral object communication apparatus in accordance with a request for providing information when the request for providing information on a peripheral object is received from the peripheral object communication apparatus.
